(19) United States
(12) Patent Application Publication
(10) Pub. No.: US 2004/0094681 A1
(43) Pub. Date: May 20, 2004

(54) Bracket element

(76) Inventor: Ulrich Birnbaum, Penzing (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/638,176

(22) Filed: Aug. 7, 2003

(30) Foreign Application Priority Data
Aug. 8, 2002 (DE) 102 36 553.9

(51) Int. Cl. F16L 3/00

(52) U.S. Cl. 248/300

(57) ABSTRACT

A bracket element (1) for fastening a mounting element to a support has a first member (2) and a second member (3). The support has, at least on one of its outer walls, openings in a predetermined spacing. The first member (2) is provided with an opening (4) corresponding to the openings in the outer wall of the support for fastening the bracket element (1) on the support. The first member (2) further has a guide edge (5) that is used for orienting the bracket element (1) on the support. In the oriented condition of the bracket element (1), the elongated opening (6) arranged on the second member (3) runs parallel to the support.

### BACKGROUND OF THE INVENTION

The invention relates to a bracket element for fastening a mounting element to a support, in particular a system support of an assembly system, wherein the support is a profile section and has openings in a predefined spacing on at least one outer wall. The bracket element has a first member and a second member that is oriented essentially perpendicular to the first member, wherein the first member has at least one opening for fastening of the bracket element to the support and the second member has at least one elongated opening for fastening the mounting element to the bracket element. Furthermore, the invention relates to a conduit line fastening for affixing a conduit line, such as a pipe or the like, to a support, in particular to a system support of an assembly system.

In industrial conduit construction, conduit systems are guided via racks made of steel profile sections. Along with the standard profile sections of steel supports, system supports of assembly systems are used for constructing these racks. The conduit systems must be secured against undesired displacement at the profile sections. In uninsulated pipe lines, for example, mounting elements, whose free ends can be welded to a profile support using welding strips, are led around the pipe lines. Another possibility is represented by claw couplings that firmly clamp a support plate arranged on the pipe lines on the surface of the profile support.

The drawback in the known solution is that the welds can be created only by specialized craftsmen and these are costly to produce. For example, prior to the welding operation, the surface protection of the support in the zone of the connection must be removed and then the weld site must be protected against corrosion. In areas at risk of explosion, welding operations can be carried out only after an expensive approval process and additional temporary construction procedures. In welded connections, adaptations and modifications can be made only at great expense. Claw elements have the drawback that, for example, for the different pipe diameters and/or support plates and the different profile cross-sections a multitude of parts that are cost-intensive to manufacture must be available.

### SUMMARY OF THE INVENTION

The object of the present invention is to provide a bracket element that is simple to manufacture, that makes of a mounting element to a support possible and that can be flexibly implemented. The bracket element should be suitable as a component of a conduit system fastening.

This object is achieved, in accordance with the invention, by a bracket element for fastening a mounting element to a support, in particular to a system support of an assembly system, a first member and a second member, essentially perpendicularly oriented to the first member. The first member has at least one opening for fastening the bracket element to the support and the second member has at least one elongated opening for fastening the mounting element to the bracket element. The first member of the bracket element comprises an alignment means for aligning of the bracket element on the support, wherein the elongated opening is arranged in the second member parallel to the alignment means.

The first member of the bracket element has, for example, as the alignment means, a guide that is adapted to the support. Using said guide, the bracket element can be oriented, positioned on the support and affixed using a fastening means to the support. The support is a profile section and has openings in a predefined spacing on at least one outer wall. A suitable fastening means is, for example, a screw, that has on one end a screw head and on the other end a thread segment. The screw is passed through the opening in the first member and the openings in the outer walls of the support, whereby the opening in the first member is configured preferably identical to the openings in the support. A nut is applied to the thread segment by means of which the fastening means is tensioned. The openings in the outer walls of the support are configured preferably as square holes. The screw has a guide segment that is configured complementary to the opening and which secures the screw in the opening against rotation, so that the screw can be tightened without a counter-holding means. The opening in the first member of the bracket element preferably has the same form as the openings in the outer walls of the support. If the bracket were to be fastened at an inappropriate place on the support or if the circumstances change, such that a relocation of the fastened bracket element is necessary, the fastening means can be loosened and the bracket element re-used.

The mounting means are fastened in the elongated opening that is oriented parallel to the support, disposed in the second member. The minimal length of the elongated opening corresponds preferably to the sum of the spacing of two openings disposed in the outer wall of the support and the inside diameter of one of said openings. The mounting element can be continuously positioned, loosened from the grid spacing of the openings, in at least one of the outer walls of the support. The bracket element can also be arranged on so-called T and I supports, whereby these have openings only in a predefined spacing in the rib of the T or the I support.

The bracket element according to the invention can also be used for fastening the support to a substrate such as to a wall, a ceiling or on a floor, for example. As a factor of the existing loads, more than one bracket element for fastening the support to a substrate may be used. The fastening means for fastening the bracket element to the substrate is preferably adapted to the material properties of the respective substrate.

Preferably, the outer contour of the support surface of at least the first member of the bracket element is complementary to the outer contour of the support surface of the support. The support surface of the first member configured complementary to the outer contour of the support can be used as an alignment means for the bracket element, so that a guide for aligning the bracket element can be eliminated. Preferably, the bracket element is supported in the event of tensile loading on the second member on the flange of the support. Furthermore, the first member abuts flatly on the surface when the bracket element is disposed on the support. If a system support of an assembly system is used for erecting a rack construction, the first member is at least complementary to the available lateral surfaces in the assembled condition of the system support.

Preferably, the mounting element that can be introduced into the bracket element is at least one part of a pipe line fastening system. With the possibility of continuous positioning of the mounting element on the bracket element, all forms of pipe lines can be fastened to different supports.

Preferably, the bracket-element is a punch/bent part. The bracket element is, for example, fabricated using a steel flat or sheet. The bracket element is simple and inexpensive to manufacture.

A conduit system fastening according to the invention for affixing a conduit system such as a pipe and the like to a support, in particular a system support of an assembly system, wherein the support is a profile section and has openings in a predefined spacing on at least one of the outer walls of the support, comprises at least two bracket elements for fastening at least on mounting element to the support, and at least one mounting element for fastening a conduit system to the bracket elements. The at least one mounting element preferably has a first member and a second member that is connected to the first member by a connecting segment. The free ends of the members of the mounting element have fastening means and the free ends of the members of the mounting element can be passed through the elongated openings of the bracket element.

The conduit system to be affixed is laid in accordance with the existing conditions using the rack construction constructed of supports and without taking into account the fastening possibilities of the conduit system to the support. The conduit system, for example, lies on a horizontally placed support of the rack construction. Then the bracket elements are arranged on the openings in the outer wall of the support, which most approximate the planned horizontal line, which runs in the vertical sense through the existing lateral marginal segments of the conduit system. The mounting element can, for example, be an L-shaped configuration with a first and a second member. One of these members serves as the mounting element for the conduit system and the other member is passed through the elongated opening of one of the arranged bracket elements. The mounting element can be continuously slid in the elongated opening of the bracket element and fixed in the desired position using the fastening means. In the other bracket element arranged on the support, a second L-shaped mounting element is similarly provided so that the conduit system is securely affixed to the support. The bracket elements assume the rough grid of the upper support and the displaceable mounting elements in the elongated openings of the bracket element make possible the continuous fine adjustment.

In a preferred embodiment of the mounting element, it is essentially U-shaped in its configuration. The conduit system is enclosed by this mounting element. Since the mounting element can be moved back and forth with its members in the elongated openings of the two bracket elements, the conduit system can be affixed in its laid out position.

The predetermined grid of the openings in the outer wall of the support need not be taken into consideration at the time of laying out the conduit system for the purpose of its assembly. Using only two bracket elements all mounting elements having the same cross-section can be fastened to one support. Independent of the configuration of the mounting element and the cross-sectional shape of the conduit system to be fastened.

Preferably, the mounting element is fabricated from a round profile section, optionally out of metal. The round profile section is preferably a round steel, which can be bent into the desired shape. As an alternative to a metal material, the mounting element can be fabricated out of a plastic, which can be easily shaped and maintains the form created for it. Along with a rounded profile cross-section, the cross-section of the mounting element can, for example, be polygonal or oval. Even the use of simply deformable hollow-profile cross-sections is possible.

Preferably, the inner contour of the connection segment of the mounting element is complementary to the outer contour of the conduit system. If the conduit system to be affixed is, for example, a pipe line, the connection section preferably has a mounting section configured as a semi-circle, which encloses the pipe at its outer wall and on the ends of the semi-circular section has members that run linearly. If the outer contour of the conduit system is rectangular, the mounting element is preferably U-shaped with members deflected rectangular to the connection section. The mounting element encloses the conduit system laterally such that the conduit system is held against lateral displacement.

Advantageously, the fastening means comprises screw means at the free ends of the members of the mounting element for affixing the at least one mounting element to the bracket elements. The free ends of the members have, for example, a threaded segment, at which the mounting element can be tightened onto the bracket element by means of a nut. Further possibilities for fastening the mounting element to the bracket elements include clamp parts that are pushed over the free ends of the members and prevent the conduit system from lifting off from the support.

### BRIEF DESCRIPTION OF THE INVENTION

An exemplary embodiment of the invention will be more completely described with reference to the drawings, wherein:

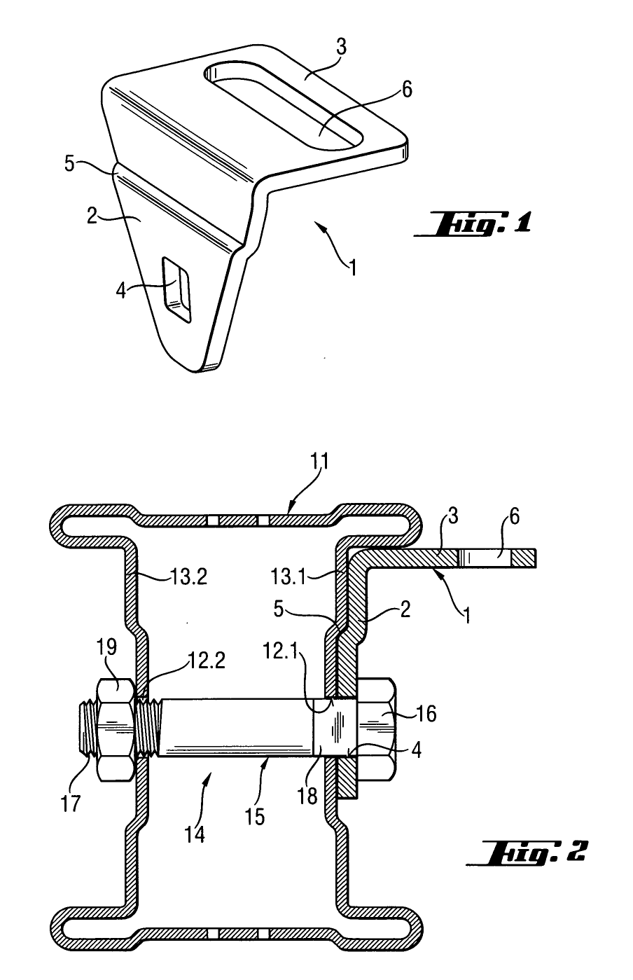

FIG. 1 shows a perspective view of a bracket element according to the invention;

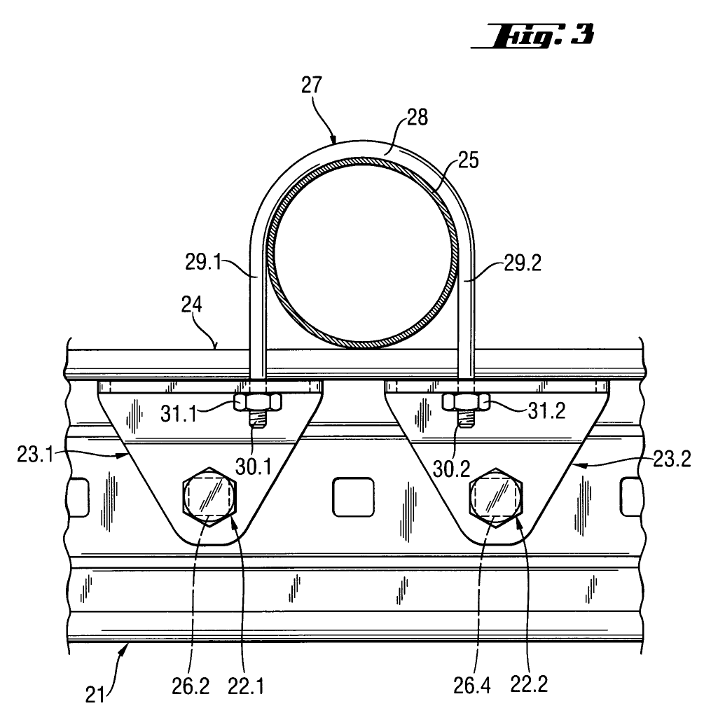

FIG. 2 shows a cross-section through a system support with an arranged bracket element according to the invention; and

FIG. 3 shows a view onto a conduit system fastening according to the invention.

### DETAILED DESCRIPTION OF THE INVENTION

In principle, the same parts are provided with the same references in the Figures.

FIG. 1 shows a perspective view of a bracket element according to the invention. The bracket element 1 comprises a first member 2 and a second member 3. The first member 2 has a square opening 4, which is configured to correspond with an opening in an outer wall of the support, on which the bracket element 1 is arranged. The member 2 is contoured and has a guide edge 5 that aligns the bracket element 1 at the time of positioning and fastening to the support. An elongated opening is formed in the second member 3. The minimal length of the elongated opening preferably corresponds to the sum of the spacing of two openings in the outer wall of the support and the inside diameter of the opening. The openings in the outer wall of the support, for example, have an axial spacing of 50.0 mm and an inside diameter of 13.5 mm. Accordingly, the length of the elongated opening in this exemplary embodiment would be 65.0 mm.

FIG. 2 shows a cross-section through a system support having a bracket element arranged thereon according to the invention. The bracket element 1 is arranged on the system support 11. The first member 2 is complementary to the outer surface of the system support 11. The bracket element 1 is aligned such that the elongated opening 6 in the second member 3 runs parallel to the system support 11 when the bracket element 1 is fastened to the system support 11. The fastening means 14 pass through the opening 4 of the bracket element 1 and through the openings 12.1 and 12.2 in the lateral outer walls 13.1 or 13.2 for fastening the bracket element 1 to the system support 11.

The fastening means 14 comprise a screw 15, which has a screw head 16 at one end and a threaded segment 17 on the other end. A guide segment 18 is configured with planar surfaces in the zone of the screw head 16. The guide segment 18 is complementary to the inner contour of the opening 12.1 in the outer wall 13.1 of the system support 11 or complementary to the opening 4 in the first member 2 of the bracket element 1. A nut 19 is provided on the threaded segment 17 for the purpose of tightening the fastening means 14. Using the guide segment 18, a rotation of the screw 15 is prevented at the time of tightening of the fastening means 14.

A view onto a conduit system fastening means according to the invention is represented in FIG. 3. The previously laid out pipe line 25 lies on the top side 24 of the system support 21, which, for example, is a horizontal segment of a rack construction. Two bracket elements 23.1 and 23.2 are fastened to the system support 21 by fastening means 22.1 and 22.2. The bracket elements 23.1 and 23.2 are arranged at the openings 26.2 and 26.4 of the system support 21, since these openings 26.2 and 26.4 most approximate the vertically oriented tangents of the lateral pipe zone. The pipe line 25 is enclosed by a mounting member 27, which has a mounting segment 28 abutting the outer wall and members 29.1 and 29.2 connecting to same. The free ends 30.1 and 30.2 of the members 29.1 or 29.2 are led through the elongated openings in the bracket elements 23.1 and 23.2. The free ends 30.1 and 30.2 have threaded segments, on which nuts 31.1 or 31.2 are arranged for tightening the mounting member 27 with the bracket elements 23.1 and 23.2. The pipe line 25 need not be aligned on the coarse grid of the openings (e.g. 26.2 and 26.4) on the system support 21 at the time of laying because the free ends 30.1 and 30.2 can be displaced in the elongated openings continuously, parallel to the system support 21.

It must be noted that a bracket element and a conduit system fastening means that are simple to manufacture are provided that simplify the fastening of a mounting element to a support that is flexible to implement. The bracket element can be mounted and removed without breaching the surface protection and is configured as a re-usable part.

What is claimed is:

1. A bracket element for fastening a mounting element (27) to a system support (11; 21) of an assembly system; the support (11; 21) is a profile section and has openings (12.1, 12.2; 26.2, 26.4) in a predefined spacing on at least one outer wall (13.1, 13.2); the bracket element (1; 23.1, 23.2) has a first member (2) and a second member (3) that is oriented vertical to the first member (2); the first member (2) has at least one opening (4) for fastening the bracket element (1; 23.1, 23.2) to the support (11; 21) and the second member (3) has at least one elongated opening for fastening the mounting element (27) to the bracket element (1; 23.1, 23.2), wherein the first member (2) of the bracket element (1; 23.1, 23.2) comprises an alignment means (5) for orienting the bracket element (1; 23.1, 23.2) on the support (11; 21) and wherein the elongated opening (6) in the second member (3) is arranged parallel to the alignment means (5).

2. The bracket element of claim 1, wherein the outer contour of the support surface at least of the first member (2) of the bracket element (1; 23.1, 23.2) is complementary to the outer contour of the support surface of the support (11; 21).

3. The bracket element of claim 1, wherein the mounting element (27) being introduced into the bracket element (1; 23.1, 23.2) is at least a part of a conduit system fastening.

4. The bracket element of claim 3, wherein the bracket element (1; 23.1, 23.2) is a punch/bend part.

5. A conduit fastening system for affixing a pipe (25) to a system support (21) of an assembly system, wherein the support (21) is a profile section and has openings (26.2, 26.4) in a predefined spacing on at least one of the outer walls of the support, wherein the conduit system fastening system comprises at least two bracket elements (23.1, 23.2) for the purpose of fastening at least one mounting element (27) to the support (21), at least one mounting element (27) for fastening a conduit system to the bracket elements (23.1, 23.2), wherein the at least one mounting element (27) has a first member (29.1) and a second member (29.2) that is connected with the first member (29.1) via a connection segment (28) and the first and second members (29.1, 29.2) of the mounting element (27) have free ends (30.1, 30.2) with fastening means and the free ends (30.1, 30.2) can be passed through the elongated openings of the bracket elements (23.1, 23.2).

6. The conduit system fastening system of claim 5, wherein the mounting element (27) is fabricated from a round section.

7. The conduit system fastening system of claim 5, wherein the inner contour of the connection segment (28) of the mounting element (27) is complementary to the outer contour of the conduit system (25).

8. The conduit system fastening system of claim 5, wherein the fastening means comprise at the free ends (30.1, 30.2) of the first and second members (29.1, 29.2) of the mounting element (27) screw means for affixing the at least one mounting element (27) to the bracket elements (23.1, 23.2).

9. The conduit system fastening system of claim 6, wherein the round section is made of metal.
